(19) United States
(12) Patent Application Publication
(10) Pub. No.: US 2011/0270850 A1
(43) Pub. Date: Nov. 3, 2011

(54) Prioritization of Resources based on User Activities

(75) Inventors: John S. Wana, Seattle, WA (US); George Perantatos, Seattle, WA (US); Ilya Tumanov, Redmond, WA (US); Brian R. Meyers, Issaquah, WA (US)

(73) Assignee: MICROSOFT CORPORATION, Redmond, WA (US)

(21) Appl. No.: 12/771,290

(22) Filed: Apr. 30, 2010

(51) Int. Cl. G06F 17/30; G06F 15/16

(52) U.S. Cl. 707/749; 709/217; 707/769; 707/E17.014; 707/E17.032

(57) ABSTRACT

A computing system generates resource data that represents a resource. The content of the resource data is dependent on a ranking of resources in a set of resources. The ranking of the resources in the set of resources is dependent on interactions between users in a set of users and the resources in the set of resources. The ranking of the resources in the set of resources also is dependent on a degree to which each user in the set of users is related to a user.

### BACKGROUND

Enterprises and other organizations allow users to generate and access a large number of resources. For example, enterprises can allow employees to generate and access a large number of web pages, word processor documents, spreadsheet documents, email messages, electronic calendar appointments, database items, and so on. As the number of accessible resources grows, it can become progressively harder for users to find the resources for which they are looking.

To make it easier to find the resources for which users are looking, enterprises and other organizations frequently implement tools that allow users identify resources that are likely to be the ones for which the users are looking. For example, an enterprise can implement a search system that allows employees of the enterprise to find resources on an intranet site that satisfy user-selected search queries. In another example, an enterprise can deploy an email client that allows users to sort the email messages in their mailboxes in various ways. For instance, the email client can allow users to sort the email messages in their mailboxes based on the sending times of the email messages.

Furthermore, the tools can sort the resources such that resources that are likely to have greater relevance are prioritized. However, resources that are relevant to some users may not be relevant to other users. Consequently, prioritizing resources can, in some circumstances, diminish the likelihood that users are able to conveniently find the resources for which they are looking.

### SUMMARY

A computing system generates resource data that represents a resource. The content of the resource data is dependent on a ranking of resources. For example, a search results web page can contain links to web pages that satisfy a search query. In this example, the order of the links is dependent on a ranking of the web pages that satisfy the search query. The ranking of the resources is dependent on interactions between users and the resources. The ranking of the resources is also dependent on a degree to which each user in the set of users is related to a user.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system.

FIG. 2 is a flowchart illustrating an example operation performed by a client system.

FIG. 3A is a flowchart illustrating an example operation performed by a server activity collection system with regard to server-generated activity data.

FIG. 3B is a flowchart illustrating an example operation performed by the server activity collection system with regard to client-generated activity data.

FIG. 4 is a flowchart illustrating an example operation performed by a resource server.

FIG. 5 is a flowchart illustrating an example operation performed by the server system to generate resource data based on activity data.

FIG. 6 is a block diagram illustrating an example computing device.

### DETAILED DESCRIPTION

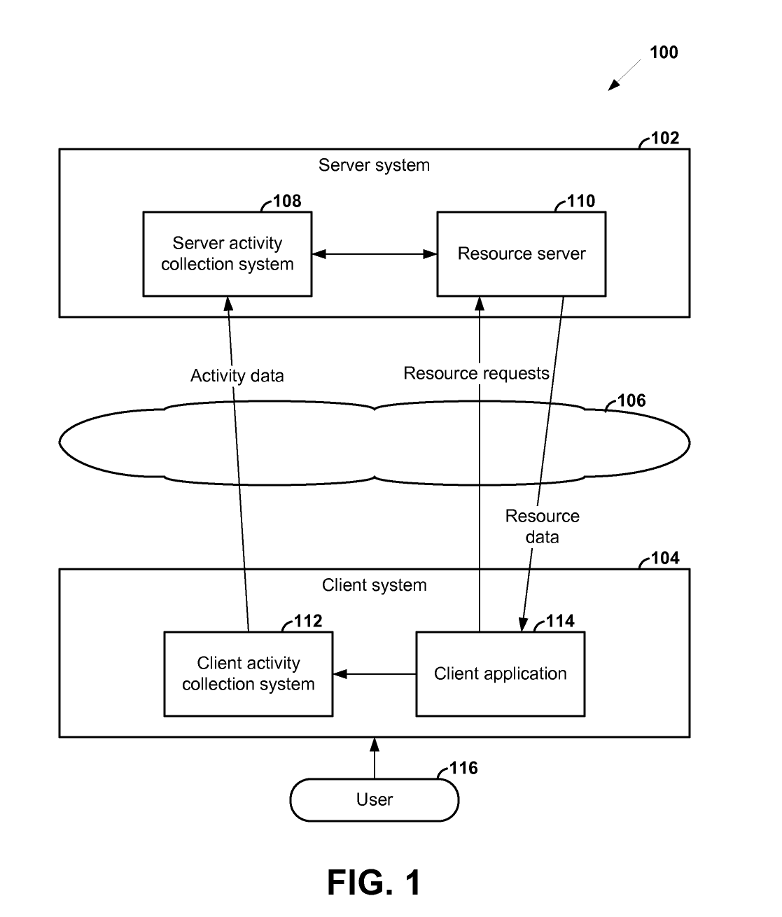

FIG. 1 is a block diagram illustrating an example system 100. The system 100 comprises a server system 102, a client system 104, and a network 106. It should be appreciated that the system 100 can contain components in addition to those illustrated in the example of FIG. 1. Such additional components are omitted from FIG. 1 for the sake of clarity.

The server system 102 is a system comprising one or more computing devices. A computing device is a physical, tangible device that processes information. In various embodiments, the server system 102 comprises various types of computing devices. For example, the server system 102 can comprise one or more desktop computers, laptop computers, netbook computers, handheld computing devices, smartphones, standalone server devices, blade server devices, mainframe computers, supercomputers, and/or other types of computing devices. In embodiments where the server system 102 comprises more than one computing device, the computing devices in the server system 102 can be distributed across various locations and communicate via a communications network, such as the Internet or a local area network.

The client system 104 is also a system comprising one or more computing devices. In various embodiments, the client system 104 comprises various types of computing devices. For example, the client system 104 can comprise any of the types of computing devices listed above with regard to the server system 102.

The network 106 is a communications network comprises a collection of computing devices and links that facilitate communication among the server system 102 and the client system 104. In various embodiments, the network 106 includes various types of computing devices. For example, the network 106 can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices. In various embodiments, the network 106 includes various types of links. For example, the network 106 can include wired and/or wireless links. Furthermore, in various embodiments, the network 106 is implemented at various scales. For example, the network 106 can be implemented as one or more local area networks (LANs), metropolitan area networks, subnets, wide area networks (such as the Internet), or can be implemented at another scale.

One or more data storage systems in the server system 102 store computer-readable instructions that, when executed by one or more processing units in the server system 102, cause the server system 102 to provide a server activity collection system 108 and a resource server 110. A data storage system is a system comprising one or more computer-readable data storage media. A computer-readable data storage medium is a physical device or article of manufacture that is capable of storing data in a volatile or non-volatile way. In some embodiments, the data storage system comprises one or more computer-readable data storage media that are non-transient. Example types of computer-readable data storage media include random access memory (RAM), read-only memory (ROM), optical discs (e.g., CD-ROMs, DVDs, BluRay discs, HDDVD discs, etc.), magnetic disks (e.g., hard disk drives, floppy disks, etc.), solid state memory devices (e.g., flash memory drives), EEPROMS, field programmable gate arrays, and so on.

In some embodiments where the one or more data storage systems in the server system 102 comprise more than one computer-readable data storage medium, the computer-readable data storage media are distributed across various geographical locations. In some embodiments where the data storage system in the server system 102 comprises more than one computer-readable data storage medium, the computer-readable instructions associated with the server activity collection system 108 and the resource server 110 are distributed across two or more of the computer-readable data storage media. In other embodiments where the data storage system in the server system 102 comprises more than one computer-readable data storage medium, the computer-readable instructions associated with the server activity collection system 108 and the resource server 110 are stored on only one of the computer-readable data storage media. It should be appreciated that in other embodiments, the server system 102 provides more or fewer components than are illustrated in the example of FIG. 1. Moreover, it should be appreciated that FIG. 1 shows the server system 102 in a simplified form for ease of comprehension.

One or more data storage systems in the client system 104 store computer-readable instructions that, when executed by one or more processing units in the client system 104, cause the client system 104 to provide a client activity collection system 112 and a client application 114. In some embodiments where the data storage system in the client system 104 comprises more than one computer-readable data storage medium, the computer-readable instructions associated with the client activity collection system 112 and the client application 114 are distributed across two or more of the computer-readable data storage media. In other embodiments where the data storage system in the client system 104 comprises more than one computer-readable data storage medium, the computer-readable instructions associated with the client activity collection system 112 and the client application 114 are stored on only one of the computer-readable data storage media. It should be appreciated that in other embodiments, the client system 104 includes more or fewer components than are illustrated in the example of FIG. 1. Moreover, it should be appreciated that FIG. 1 shows the client system 104 in a simplified form for ease of comprehension.

In various embodiments, the client application 114 can be various types of applications. For example, the client application 114 can be a web browser application, such as the MICROSOFT INTERNET EXPLORER® web browser, the GOOGLE CHROME web browser, or the MOZILLA FIREFOX web browser. In other embodiments, the client application 114 can be an email client, such as the MICROSOFT OUTLOOK® email client. In yet other embodiments, the client application 114 can be other types of applications, such as word processing applications, spreadsheet applications, database applications, document management service clients, and other types of client applications.

A user 116 uses the client application 114 provided by the client system 104 to request resources hosted by the resource server 110 provided by the server system 102. A resource is an identifiable set of data. Example types of resources include, but are not limited to, static or dynamically-generated web pages, word processor documents, spreadsheet documents, databases, database entries, email messages, electronic calendar appointments, electronic task list tasks, PDF documents, video files and streams, audio files and streams, and other types of identifiable sets of data. To request resources hosted by the resource server 110, the client application 114 sends resource requests to the resource server 110 via the network 106. In response to resource requests from the client application 114, the resource server 110 sends resource data to the client application 114 via the network 106. The resource data represents the requested resources. The client application 114 processes the resource data received from the resource server 110 to present the requested resources to the user 116.

The client activity collection system 112 generates activity data that indicates how the user 116 interacted with resources. For example, the client activity collection system 112 can generate activity data indicating a length of time a window containing a resource was in the foreground of a user interface displayed to the user 116, how many times the user 116 brought a window containing a resource into the foreground of a user interface displayed to the user 116, how many times the user 116 printed a resource, how many times the user 116 copied and pasted information out of a resource, whether the user 116 edited a resource, whether the user 116 forwarded a resource to another user, a length of time the user 116 was working (e.g., performing keyboard and/or mouse activity) in a window containing the resource, and other types of user activities detectable from the client system 104.

The client activity collection system 112 sends activity data to the server activity collection system 108 via the network 106. When the server activity collection system 108 receives the activity data from the client activity collection system 112, the server activity collection system 108 records at least some of the activity data in such a way that the activity data remains associated with the user 116. In other words, the server activity collection system 108 maintains the client-generated activity data such that it is possible at least to some degree to determine how the user 116, as an individual, interacted with resources hosted by the resource server 110. That is, at least some of the activity data is not aggregated with the activity data of other users or made anonymous.

The server activity collection system 108 also receives activity data indicating how other users in a population interacted with resources hosted by the resource server 110. The population includes the user 116. In various embodiments, the population is defined in various ways. For example, the server activity collection system 108 can collect activity data from client activity collection systems installed at client systems used by some or all employees in an enterprise. In another example, the server activity collection system 108 can collect activity data from client activity collection systems installed at client systems used by people who have registered for a service or otherwise voluntarily joined the community. Like the activity data relating to the user 116, the server activity collection system 108 stores at least some of the activity data relating to other users in such a way that the activity data relating to the other users remains associated with the other users. In other words, at least some of the activity data relating to the other users is not aggregated or made anonymous.

Furthermore, in some embodiments, the server activity collection system 108 itself generates and records activity data that indicates how users interact with resources hosted by the resource server 110. For example, the server activity collection system 108 can generate information about how many times the user 116 requested a resource, whether the user 116 modified the resource, whether the user 116 performed another search after receiving a search result web page containing the resource, times and dates the user 116 requested the resource, whether the user 116 has previously requested the resource, and other types of user activities detectable from the server system 102.

To provide some resources to the client system 104, the resource server 110 dynamically generates resource data that represents the resources. In some instances, the content of the resource data representing a resource is dependent on a ranking of other resources. The other resources may or may not be hosted by the resource server 110. For example, the resource server 110 can host a search result web page containing a list of links to resources that satisfy a search query. In this example, the order of the links can be dependent on the ranking of the resources that satisfy the search query. In another example, the resource server 110 can host a resource that comprises a ranked list of email messages.

The ranking of the resources is dependent on interactions between users in a set of users and resources in the set of resources. An interaction between a user and a resource is an action performed by the user on the resource. In various circumstances, users can have a wide variety of interactions with resources. For instance, a user can open, edit, print, copy data out of, follow links contained in, or perform other types of actions on a resource.

In addition, the ranking on the resources is dependent on a degree to which each user in the set of users is related to the user who requested the resources (i.e., the user 116). In various embodiments, the resource server 110 calculates the ranking in various ways. For example, in some embodiments, the resource server 110 uses the activity data collected by the server activity collection system 108 to calculate activity scores for resources in a set of resources. The activity score for a resource is based, at least in part, on the interactions between one or more users and the resource and is also based on a degree to which those users are related to the user 116. As described in detail elsewhere in this document, the resource server 110 calculates the activity scores in different ways in different embodiments. The resource server 110 uses the activity scores for at least some of the resources in the set of resources to rank the resources in the set of resources.

The resource server 110 then generates the resource data. The content of the resource data is dependent on the ranking of the resources. For example, the resource data can represent a web page containing links to at least some of the resources satisfying a search query. In this example, the resources are ranked according to the activity scores for the resources and the links are ordered according to the ranking of the resources. As described in detail elsewhere in this document, the resource server 110 generates the resource data in different ways in different embodiments.

After generating the resource data, the resource server 110 sends the resource data to the client application 114 via the network 106. Upon receiving the resource data, the client application 114 processes the resource data to present the requested resource to the user 116. In various embodiments, the client application 114 processes the resource data to present the requested resource in various ways. For example, where the resource data represents a web page containing links to resources satisfying a search query, the client application 114 can render and display the web page. In this example, the user 116 can then use links in the web page to request resources from the resource server 110. In another example, where the resource data represents an order of email messages, the client application 114 can display email messages in the order indicated by the resource data. In this way, by generating resource data that is dependent on the interactions between users and resources and the degree to which those users are related to the user 116, the user 116 may be able to conveniently find the resources that the user 116 was looking for.

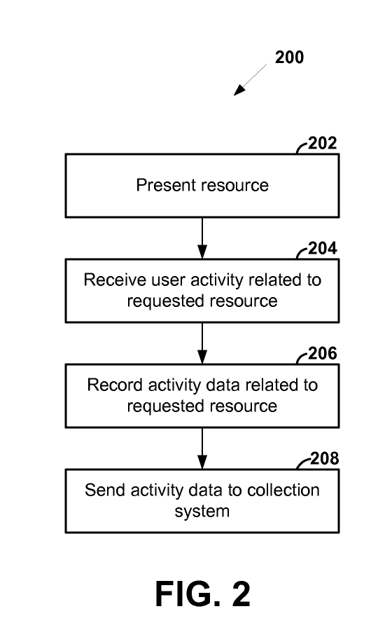

FIG. 2 is a flowchart illustrating an example operation 200 performed by the client system 104. Although the operation 200 is described with reference to the client system 104, it should be appreciated that multiple client systems can perform the operation 200 in order to retrieve resources from the server system 102 and send activity data to the server system 102. Furthermore, the operation 200 is explained with reference to the client application 114 requesting a resource from the resource server 110. In other embodiments, the client application 114 can request the resource from other resource servers.

As illustrated in the example of FIG. 2, the operation 200 begins when the client application 114 presents a resource to the user 116 (202). In various embodiments, the client application 114 performs various actions to present the resource. For example, in some embodiments, the client application 114 performs various actions to retrieve resource data that represents the resource. For instance, in some embodiments, the resource is hosted by the resource server 110. To present the resource in such embodiments, the client application 114 sends a resource request to the resource server 110. The resource request represents a request for the resource. The resource request can be formatted in various ways. For example, the client application 114 uses the Hypertext Transfer Protocol (HTTP) to send the resource request to the resource server 110. In other embodiments, the client application 114 uses a proprietary remote procedure call (RPC) protocol to send the resource request to the resource server 110. After sending the resource request, the client application 114 receives resource data from the resource server 110. The resource data represents the requested resource. The resource data can be formatted in various ways. For instance, the resource data can be formatted as an HTTP response. In other instances, the client application 114 receives the resource data as a stream. A stream is a succession of data elements supplied over time to be interpreted and rendered, in real-time, as they are received. Furthermore, in some embodiments, the client system 104 stores resource data representing the resource at a local data storage system. In such embodiments, the client application 114 retrieves the resource data from the local data storage system.

Furthermore, after the client application 114 retrieves resource data that represents the resource, the client application 114 processes the resource data to present the resource. For example, where the resource is a video stream, the client application 114, or another application under the direction of the client application 114, decodes the resource data and presents the video stream to the user 116. In another example, where the resource is an email message, the client application 114 renders the resource data to show the email message to the user 116.

Furthermore, after the client application 114 receives at least some of the resource data, the client application 114 receives user activity related to the resource (204). For example, the client application 114 can receive input from the user 116 to bring a window containing the resource into the foreground of a user interface. In another example, the client application 114 can receive input from the user 116 to copy data out of the resource. In yet another example, where the resource is an email message, the client application 114 can receive input from the user 116 to forward or reply to the email message.

When the client application 114 receives user activity related to the resource, the client activity collection system 112 records the activity data related to the resource (206). The activity data indicates how the user 116 interacted with the resource. As the user 116 continues to interact with the resource, the client activity collection system 112 continues to record activity data related to the resource. In various embodiments, the client activity collection system 112 records the activity data in various ways. For example, in some embodiments, the client activity collection system 112 stores the activity data in a relational database. In other embodiments, the client activity collection system 112 stores the activity data in a log file.

Subsequently, the client activity collection system 112 sends the recorded activity data to the server activity collection system 108 (208). In various embodiments, the client activity collection system 112 sends the recorded activity data to the server activity collection system 108 in various ways. For example, in some embodiments, the client activity collection system 112 records activity data occurring over a given time period and then sends the activity data to the server activity collection system 108 in bulk. For instance, the client activity collection system 112 can record activity data occurring over a day, an hour, a week, or another time period before sending the activity data to the server activity collection system 108. In other embodiments, the client activity collection system 112 sends activity data to the server activity collection system 108 on a continuous basis as the client activity collection system 112 records the activity data.

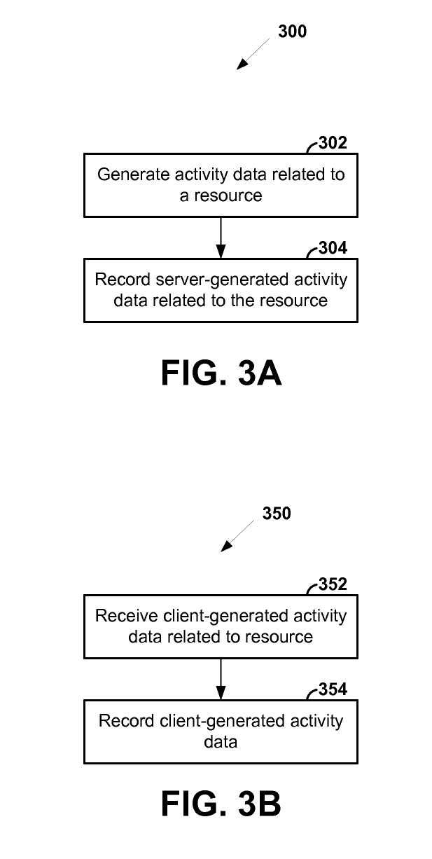

FIG. 3A is a flowchart illustrating an example operation 300 performed by the server activity collection system 108 with regard to server-generated activity data. Although the operation 300 is described with regard to the server system 102 interacting with the client system 104, it should be appreciated that the server system 102 can interact in the same or similar ways with other participating client systems. For example, the server system 102 can interact with some or all client systems in an enterprise in the same way as the client system 104.

As illustrated in the example of FIG. 3A, the operation 300 begins when the server activity collection system 108 generates server-generated activity data that indicates how the user 116 interacts with a resource (302). In various embodiments, the server activity collection system 108 generates various types of server-generated activity data. For example, the server activity collection system 108 can initially generate activity data indicating that the user 116 requested the resource. In another example, the server activity collection system 108 can generate activity data indicating that the user 116 sent a resource request for the resource from a link on another resource.

The server activity collection system 108 records the server-generated activity data related to the resource (304). The server activity collection system 108 stores the server-generated activity data such that the server-generated activity data remains associated with the user 116. In other words, the server activity collection system 108 does not make the server-generated activity data anonymous. In various embodiments, the server activity collection system 108 records the server-generated activity data in various ways. For example, in some embodiments, the server activity collection system 108 records the server-generated activity data in a relational database. In other embodiments, the server activity collection system 108 records the server-generated activity data in one or more log files.

FIG. 3B is a flowchart illustrating an example operation 350 performed by the server activity collection system 108 with regard to client-generated activity data. Although the operation 350 is described with regard to the server system 102 interacting with the client system 104, it should be appreciated that the server system 102 can interact in the same or similar ways with other participating client systems. For example, the server system 102 can interact with some or all client systems in an enterprise in the same way as the client system 104.

As illustrated in the example of FIG. 3B, the operation 350 begins when the server activity collection system 108 receives client-generated activity data from the client system 104 (352). The client-generated activity data indicates how the user 116 interacted with at least one resource. In various embodiments, the client-generated activity data is formatted in various ways. For example, in some embodiments, the client-generated activity data is formatted as one or more HTTP requests, as one or more WEBDAV requests, as one or more RPC requests, as one or more SOAP over HTTP requests, and so on.

Furthermore, in various embodiments, the server activity collection system 108 receives the client-generated activity data related to the resource in conjunction with other data. For example, in some embodiments, the server activity collection system 108 receives the client-generated activity data related to the resource along with client-generated activity data related to other resources with which the user 116 interacted. In other embodiments, the server activity collection system 108 receives the client-generated activity data related to the resource separately from client-generated activity data related to other resources with which the user 116 interacted.

Furthermore, in some embodiments, the server activity collection system 108 can receive client-generated activity data related to other resources with which the users interacted. For example, the server activity collection system 108 can receive client-generated activity data indicating how users interacted with resources hosted by servers other than the resource server 110. In another example, the server activity collection system 108 can receive client-generated activity data indicating how users interacted with resources that are generated and/or stored at client systems.

In addition, in various embodiments, the server activity collection system 108 receives the client-generated activity data at various times. For example, in some embodiments, the server activity collection system 108 receives the client-generated activity data from the client system 104 on a periodic basis. In other embodiments, the server activity collection system 108 receives the client-generated activity data from the client system 104 on a continuous basis as the client system 104 generates the client-generated activity data.

After the server activity collection system 108 receives the client-generated activity data, the server activity collection system 108 records the client-generated activity data (354). The server activity collection system 108 records the client-generated activity data received from the client system 104 such that the client-generated activity data remains associated with the user 116. In other words, the server activity collection system 108 does not make the client-generated activity data anonymous. In various embodiments, the server activity collection system 108 records the client-generated activity data in various ways. For example, in some embodiments, the server activity collection system 108 records the client-generated activity data in a relational database. The relational database may or may not be the same relational database that contains the server-generated activity data. In other embodiments, the server activity collection system 108 records the client-generated activity data in one or more log files. The one or more log files may or may not be the same log files that contain the server-generated activity data.

It should be appreciated that in other embodiments, the server activity collection system 108 does not receive or record client-generated activity data. In such embodiments, rankings of resources can be determined solely on the basis of server-generated activity data. Furthermore, it should be appreciated that in other embodiments, the server activity collection system 108 does not receive or record client-generate activity data related to some resources hosted by the resource server 110.

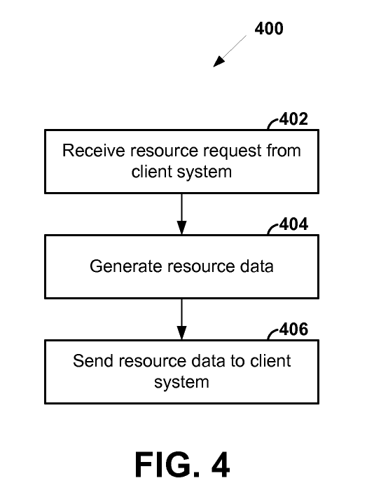

FIG. 4 is a flowchart illustrating an example operation 400 performed by the resource server 110. Although the operation 400 is described with regard to the server system 102 interacting with the client system 104, it should be appreciated that the server system 102 can interact in the same or similar ways with other participating client systems. For example, the server system 102 can interact with some or all client systems in an enterprise in the same way as the client system 104.

As illustrated in the example of FIG. 4, the operation 400 begins when the resource server 110 receives a resource request from the client application 114 (402). The resource request represents a request for a resource hosted by the resource server 110. In various embodiments, the resource request is formatted in various ways. For example, in some embodiments, the resource request is formatted using HTTP. In other embodiments, the resource request is formatted as a proprietary RPC protocol request. Furthermore, in various embodiments, the requested resource can be various types of resource, including web pages, email messages, PDF documents, word processor documents, and so on.

In response to receiving the resource request, the resource server 110 generates resource data (404). The resource data represents the requested resource. The resource server 110 performs different actions to generate the resource data depending on the requested resource. For example, if the requested resource is a static web page, the resource server 110 can generate the resource data by retrieving a Hypertext Markup Language (HTML) file from a data storage system. In another example, if the requested resource is a dynamically generated web page, the resource server 110 retrieves an extensible markup language (XML) source file and a Cascading Style Sheets (CSS) file and processes the source file and the CSS file to generate HTML data representing the web page.

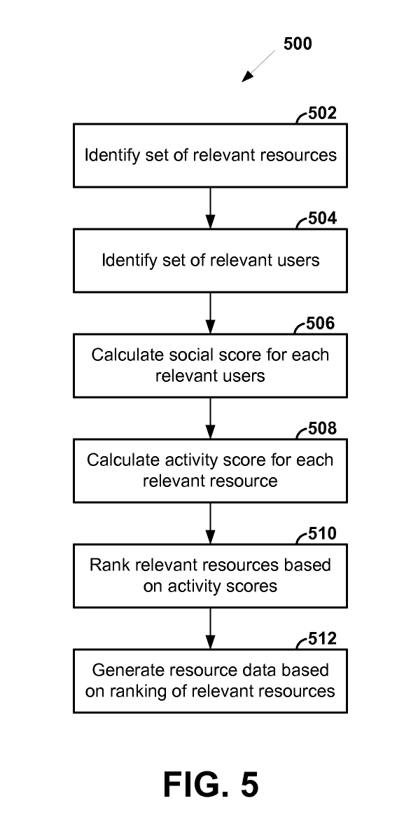

In yet another example, the resource request includes a query and the requested resource is a result web page. In this example, the resource server 110 generates the resource data by identifying result resources. The result resources are resources that satisfy the query. The result resource may or may not be hosted by the resource server 110. The resource server 110 then uses activity data collected by the server activity collection system 108 to calculate activity scores for the result resources. The activity scores are dependent on interactions between users in a set of users and the result resources and also dependent on a degree to which each user in the set of users is related to the user 116. The resource server 110 then ranks the result resources based, at least in part, on their activity scores. The resource server 110 then generates resource data representing the result page based, at least in part, on the ranking of the result resources. An example operation to generate resource data based on activity data is described herein with regard to FIG. 5.

In yet another example, the resource request represents a request for one or more ordered lists of resources in a set of resources. In this example, the resource server 110 uses the activity data collected by the server activity collection system 108 to calculate activity scores for resources in the set of resources. The resource server 110 then uses the activity scores to rank the resources in the set of resources. The resource server 110 generates resource data indicating the ranking of the resources in the set of resources.

After the resource server 110 generates the resource data, the resource server 110 sends the resource data to the client system 104 (406). In various embodiments, the resource server 110 sends the resource data to the client system 104 in various ways. For example, in some embodiments, the resource server 110 sends the resource data as an HTTP response. In other embodiments, the resource server 110 sends the resource data as a stream.

FIG. 5 is a flowchart illustrating an example operation 500 performed by the server system 102 to generate resource data based on activity data. Although the operation 400 is described with regard to the server system 102 interacting with the client system 104 and the user 116, it should be appreciated that the server system 102 can interact in the same or similar ways with other participating client systems and users.

As illustrated in the example of FIG. 5, the resource server 110 identifies a set of relevant resources (502). In various situations and embodiments, the resource server 110 identifies the set of relevant resources in various ways. For instance, in some embodiments, the user 116 specifies the set of relevant resources. For example, the user 116 can specify that the relevant resources are the email messages in a mailbox. In another example, the user 116 can specify that the set of relevant resources are the documents stored in a particular folder.

Furthermore, in some embodiments, the resource server 110 can identify the set of relevant resources based on criteria indicated by the user 116. For example, the user 116 can provide a search query in the resource request. In this example, the resource server 110 identifies the set of relevant resources as being those resources hosted by the resource server 110 that satisfy the search query.

Furthermore, in some embodiments, the resource server 110 can identify the set of relevant resources without input or guidance from the user 116. For example, the resource server 110 can identify the set of relevant resources as the resources hosted by the resource server 110 that have been created or edited by users who are in the same department as the user 116.

In addition, the resource server 110 identifies a set of relevant users (504). In some instances, the set of relevant users includes the user 116. In other instances, the set of relevant users does not include the user 116. Furthermore, in some instances, the user 116 is the only user in the set of relevant users.

The resource server 110 can identify the set of relevant users in a variety of ways. For instance, in some embodiments, the user 116 explicitly specifies the set of relevant users. For example, the user 116 can specify that the set of relevant users comprises user “A,” user “B,” and user “C.”

Furthermore, in some embodiments, the resource server 110 identifies the set of relevant users based on criteria indicated by the user 116. For example, the user 116 can specify that the set of relevant users consists of those users who subscribe to a particular mailing list, are in a particular department, have particular job titles, are located in particular places, and so on. In another example, the user 116 can specify that the set of relevant users consists of those users who are not in any user groups to which the user 116 belongs. In some embodiments, the resource server 110 accesses a directory system (e.g., an LDAP or ACTIVE DIRECTORY® system) containing information about users to identify the set of relevant users based on the criteria indicated by the user 116.

Furthermore, in some embodiments, the resource server 110 can identify the set of relevant users without input or guidance from the user 116. For example, the resource server 110 can automatically identify each email distribution list to which the user 116 belongs. In this example, the set of relevant users is the set of users who belong to the identified email distribution lists.

In another example, the resource server 110 identifies the set of relevant users as those users who are in the same management chain within an organization as the user 116. In yet another example, the resource server 110 identifies the set of relevant users as those users who are not in the same management chain within an organization as the user 116. In yet another example, the resource server 110 identifies the set of relevant users as those users who are direct or indirect connections of the user 116 in a social networking system. In yet another example, the resource server 110 identifies some combination of the sets of users described in the other examples as the set of relevant users.

After the resource server 110 has identified the set of relevant resources and the set of relevant users, the resource server 110 calculates social scores for each of the relevant users (506). The social score for a relevant user is indicates a degree to which the relevant user is related to the user 116. As mentioned above, the set of relevant users can include the user 116. The social score of the user 116 is set at a fixed value and the social scores of other users are relative to the social score of the user 116. For example, in some embodiments, the social score of the user 116 is set at 1.0. In other embodiments, the social score of the user 116 is set at various other values.

In various embodiments, the resource server 110 calculates the social scores for users other than the user 116 in various ways. For example, in some embodiments, the resource server 110 uses the following formula to calculate the social score for a relevant user u: scoreᵤ=(log₂ c)/(mₛₘₐₗₗₑₛₜ). In this formula, scoreᵤ is the social score for the relevant user u, c is the number of email distribution lists that contain both the user 116 and the relevant user u, and mₛₘₐₗₗₑₛₜ is the number of users in the smallest distribution list that contains both the user 116 and the relevant user u.

Furthermore, in some embodiments, the resource server 110 uses an alternate way of calculating the social scores for users who have specific positions in an organizational chart relative to the user 116. For example, if the user u is above the user 116 in a management chain that includes the user u and the user 116 (i.e., the user 116 reports directly or indirectly to the user u), the resource server 110 uses the following formula to calculate the social score for the user u: scoreᵤ=(1/sqrt(2πσ²)) e^{p}, where p=−(dᵤ−2)²/(2σ²). In this formula, scoreᵤ is the social score for the user u. dᵤ is the number of links in the management chain between the user u and the user 116. σ² can have various values in various embodiments. For example, in some embodiments, σ² is equal to 2.0. In some embodiments, the social score for the user u is doubled when the user 116 reports directly to the user u.

Furthermore, in this example, if the user u is below the user 116 in a management chain that includes the user u and the user 116 (i.e., the user u reports directly or indirectly to the user 116), the resource server 110 uses the following formula to calculate the social score for the user u: scoreᵤ=(1/sqrt (2 πσ²))e^{q}, where q=(−dᵤ²)/(2σ²). In this formula, scoreᵤ is the social score for the user u and dᵤ is the number of links in the management chain between the user u and the user 116. σ² can have various values in various embodiments. For example, in some embodiments, σ² is equal to 2.0.

Furthermore, in this example, if the user u is a peer of the user 116 in a management chain (i.e., the user u and the user 116 directly report to the same person), the user u has a social score equal to the social score of the user 116. For example, if the social score of the user 116 is equal to 1.0, the social scores of peers of the user 116 are also equal to 1.0.

In other embodiments, the resource server 110 uses other formulas to calculate the social score for a relevant user. Such other formulas can account for factors other than numbers of email distribution lists, the number of users in the smallest shared email distribution lists, or the number of links in a management chain between the users. For example, a relevant user's social score can be based on how close the relevant user is within an organization to the user 116, how frequently the relevant user communicates with the user 116, whether the relevant user has the same job title as the user 116, whether there are social networking links between the relevant user and the user 116, whether the relevant user and the user 116 have shared resource access patterns, and so on. In some embodiments, the resource server 110 can use a directory system of employees and/or activity data recorded by the server activity collection system 108 to retrieve such information about the relevant user.

Next, the resource server 110 calculates activity scores for each of the relevant resources (508). The activity score for a relevant resource is a measure of how relevant the relevant resources are to the user 116 based the activities of the relevant users with regard to the relevant resources and the social scores of the relevant users.

In various embodiments, the resource server 110 calculates the activity scores for the relevant resources in various ways. For example, in some embodiments, the resource server 110 first calculates a set of user interaction scores for each user-resource pair in the set of relevant users and the set of relevant resources. For example, if the set of relevant users includes users A, B, and C, and the set of relevant resources includes resources X, Y, and Z, the resource server 110 calculates a user interaction score for each of the following user-resource pairs: A-X, A-Y, A-Z, B-X, B-Y, B-Z, C-X, C-Y, and C-Z. A user interaction score for a user-resource pair indicates a level of interaction between the user in the user-resource pair and the resource in the user-resource pair and is dependent on the social score of the user in the user-resource pair. In some embodiments, the resource server 110 uses the following formula to calculate the user interaction score for a user-resource pair: aᵤ=scoreᵤ·log₂ (0.5+(count_of_activities×t_{oldest})/tᵤ). In this formula, aᵤ is the user interaction score for a user-resource pair specifying a user u. Furthermore, in this formula, scoreᵤ is the social score of the user u. count_of_activities is the number of times that the user u has interacted with the resource in the user-resource pair. The resource server 110 uses activity data recorded by the server activity collection system 108 (e.g., the client-generated and/or server-generated activity data) to obtain the count_of_activities. t_{oldest} is the time, according to the activity data recorded by the server activity collection system 108, of the oldest interaction of any user with regard to the resource in the user-resource pair. tᵤ is the time, according to the activity data recorded by the server activity collection system 108, of the most recent interaction of the user u with the resource in the user-resource pair. After calculating the user interaction scores for each of the user-resource pairs that include the resource, the resource server 110 calculates the activity score of the resource by totaling together each of the user interaction scores for user-resource pairs that include the resource.

It should be appreciated that in other embodiments, a user interaction score for a user-resource pair can be based on factors other than the number of times the user in the user-resource pair has interacted with the resource in the user-resource pair and when the user in the user-resource pair most recently interacted with the resource in the user-resource pair. For example, the user interaction score for a user-resource pair can be based at least in part on how long the user in the user-resource pair kept a window containing the resource in the foreground, how long the user worked in a window containing the resource, how many times the user brought a window containing the resource to the foreground, whether the user modified the resource, whether the user copied and pasted information from the resource, whether the user printed the resource, and so on.

After calculating the activity scores for each of the relevant resources, the resource server 110 ranks the relevant resources based on the activity scores for the relevant resources (510). In various embodiments, the resource server 110 ranks the relevant resources in various ways. For example, in some embodiments, the resource server 110 ranks the relevant resources starting with the relevant resource with the highest activity score and ending with the relevant resource with the lowest activity score. In other embodiments, the resource server 110 ranks the relevant resources according to final scores of the relevant resources. The final scores for the relevant resources are based on the activity scores of the relevant resources and other factors. For example, the resource server 110 can generate a final score for a relevant resource by adding the activity score for the relevant resource to a content score for the relevant resource based on the number of times keywords occur in the relevant resource.

After ranking the relevant resources, the resource server 110 generates resource data that is dependent, at least in part, on the ranking of the relevant resources (512). In various embodiments, the resource server 110 generates the resource data in various ways. For example, in some embodiments, the resource server 110 generates an HTML document that represents a web page containing links to at least some of the relevant resources. The links are ordered in the web page based on the ranking of the relevant resources. In another example, the resource server 110 generates an XML document containing a list of identifiers of relevant resources, ordered according to the ranking of the relevant resources.

Furthermore, in some embodiments, the resource server 110 generates the resource data by performing steps 506, 508, and 510 with regard to a different set of relevant resources or a different set of relevant users. For example, the resource server 110 can generate a first ranking of the relevant resources by performing the steps 506, 508, and 510 where the only relevant user is the user 116 and can generate a second ranking of the relevant resources by performing the steps 506, 508, and 510 where the set of relevant users includes the users who report to the user 116. In this example, the resource server 110 generates an HTML document representing a web page containing a first series of links to relevant resources ordered according to the first ranking of the relevant resources and a second series of links to relevant resources ordered according to the second ranking of the relevant resources. In this way, the user 116 can see the resources that may be most relevant to the user 116 personally and the resources that may be most relevant to the users who report to the user 116.

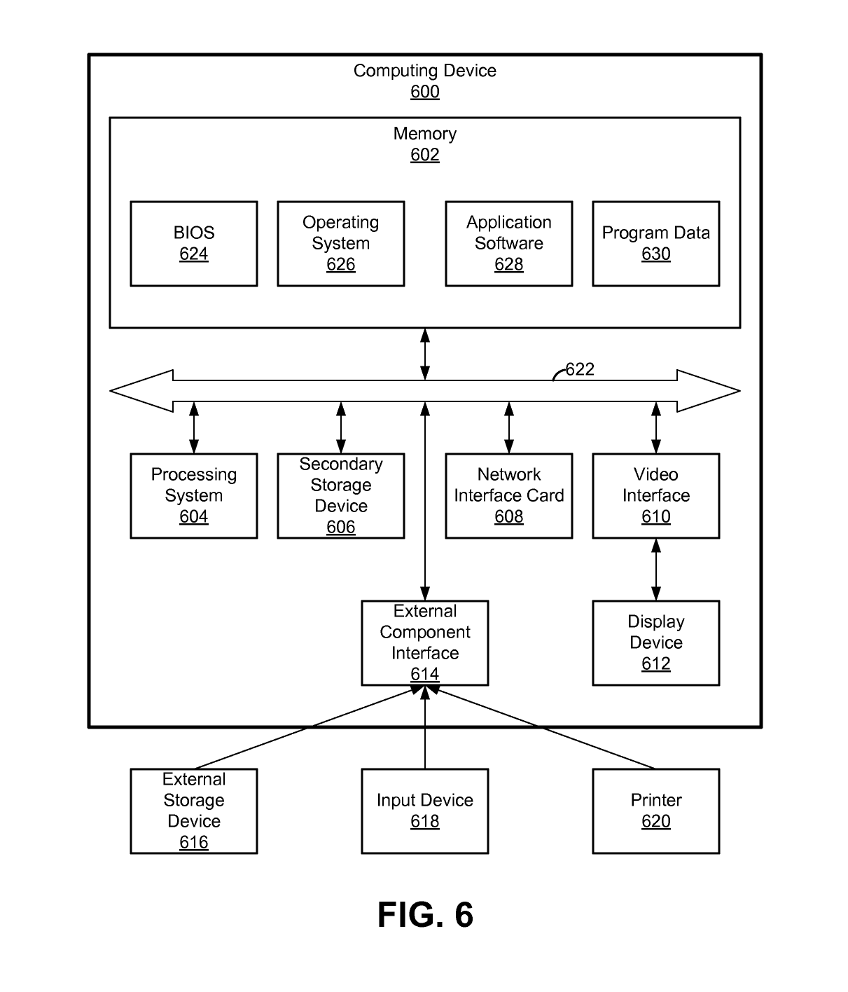

FIG. 6 is a block diagram illustrating an example computing device 600. In some embodiments, the server system 102 and/or the client system 104 are implemented using one or more computing devices like the computing device 600. It should be appreciated that in other embodiments, the server system 102 and/or the client system 104 are implemented using computing devices having hardware components other than those illustrated in the example of FIG. 6.

In different embodiments, computing devices are implemented in different ways. For instance, in the example of FIG. 6, the computing device 600 comprises a memory 602, a processing system 604, a secondary storage device 606, a network interface card 608, a video interface 610, a display device 612, an external component interface 614, an external storage device 616, an input device 618, a printer 620, and a communication medium 622. In other embodiments, computing devices are implemented using more or fewer hardware components. For instance, in another example embodiment, a computing device does not include a video interface, a display device, an external storage device, or an input device.

The memory 602 includes one or more computer-readable data storage media capable of storing data and/or instructions. A computer-readable data storage medium is a device or article of manufacture that stores data and/or software instructions readable by a computing device. In different embodiments, the memory 602 is implemented in different ways. For instance, in various embodiments, the memory 602 is implemented using various types of computer-readable data storage media. Example types of computer-readable data storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing system 604 includes one or more physical integrated circuits that selectively execute software instructions. In various embodiments, the processing system 604 is implemented in various ways. For instance, in one example embodiment, the processing system 604 is implemented as one or more processing cores. For instance, in this example embodiment, the processing system 604 may be implemented as one or more Intel Core 2 microprocessors. In another example embodiment, the processing system 604 is implemented as one or more separate microprocessors. In yet another example embodiment, the processing system 604 is implemented as an ASIC that provides specific functionality. In yet another example embodiment, the processing system 604 provides specific functionality by using an ASIC and by executing software instructions.

In different embodiments, the processing system 604 executes software instructions in different instruction sets. For instance, in various embodiments, the processing system 604 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 606 includes one or more computer-readable data storage media. The secondary storage device 606 stores data and software instructions not directly accessible by the processing system 604. In other words, the processing system 604 performs an I/O operation to retrieve data and/or software instructions from the secondary storage device 606. In various embodiments, the secondary storage device 606 is implemented by various types of computer-readable data storage media. For instance, the secondary storage device 606 may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card 608 enables the computing device 600 to send data to and receive data from a computer communication network. In different embodiments, the network interface card 608 is implemented in different ways. For example, in various embodiments, the network interface card 608 is implemented as an Ethernet interface, a token-ring network interface, a fiber optic network interface, a wireless network interface (e.g., WiFi, WiMax, etc.), or another type of network interface.

The video interface 610 enables the computing device 600 to output video information to the display device 612. In different embodiments, the video interface 610 is implemented in different ways. For instance, in one example embodiment, the video interface 610 is integrated into a motherboard of the computing device 600. In another example embodiment, the video interface 610 is a video expansion card. Example types of video expansion cards include Radeon graphics cards manufactured by Advanced Micro Devices, Inc. of Sunnyvale, Calif., Geforce graphics cards manufactured by Nvidia Corporation of Santa Clara, Calif., and other types of graphics cards.

In various embodiments, the display device 612 is implemented as various types of display devices. Example types of display devices include, but are not limited to, cathode-ray tube displays, LCD display panels, plasma screen display panels, touch-sensitive display panels, LED screens, projectors, and other types of display devices. In various embodiments, the video interface 610 communicates with the display device 612 in various ways. For instance, in various embodiments, the video interface 610 communicates with the display device 612 via a Universal Serial Bus (USB) connector, a VGA connector, a digital visual interface (DVI) connector, an S-Video connector, a High-Definition Multimedia Interface (HDMI) interface, a DisplayPort connector, or other types of connectors.

The external component interface 614 enables the computing device 600 to communicate with external devices. In various embodiments, the external component interface 614 is implemented in different ways. For instance, in one example embodiment, the external component interface 614 is a USB interface. In other example embodiments, the computing device 600 is a FireWire interface, a serial port interface, a parallel port interface, a PS/2 interface, and/or another type of interface that enables the computing device 600 to communicate with external components.

In different embodiments, the external component interface 614 enables the computing device 600 to communicate with different external components. For instance, in the example of FIG. 6, the external component interface 614 enables the computing device 600 to communicate with the external storage device 616, the input device 618, and the printer 620. In other embodiments, the external component interface 614 enables the computing device 600 to communicate with more or fewer external components. Other example types of external components include, but are not limited to, speakers, phone charging jacks, modems, media player docks, other computing devices, scanners, digital cameras, a fingerprint reader, and other devices that can be connected to the computing device 600.

The external storage device 616 is an external component comprising one or more computer readable data storage media. Different implementations of the computing device 600 interface with different types of external storage devices. Example types of external storage devices include, but are not limited to, magnetic tape drives, flash memory modules, magnetic disk drives, optical disc drives, flash memory units, zip disk drives, optical jukeboxes, and other types of devices comprising one or more computer-readable data storage media. The input device 618 is an external component that provides user input to the computing device 600. Different implementations of the computing device 600 interface with different types of input devices. Example types of input devices include, but are not limited to, keyboards, mice, trackballs, stylus input devices, key pads, microphones, joysticks, touch-sensitive display screens, and other types of devices that provide user input to the computing device 600. The printer 620 is an external device that prints data to paper. Different implementations of the computing device 600 interface with different types of printers. Example types of printers include, but are not limited to laser printers, ink jet printers, photo printers, copy machines, fax machines, receipt printers, dot matrix printers, or other types of devices that print data to paper.

The communications medium 622 facilitates communication among the hardware components of the computing device 600. In different embodiments, the communications medium 622 facilitates communication among different components of the computing device 600. For instance, in the example of FIG. 6, the communications medium 622 facilitates communication among the memory 602, the processing system 604, the secondary storage device 606, the network interface card 608, the video interface 610, and the external component interface 614. In different implementations of the computing device 600, the communications medium 622 is implemented in different ways. For instance, in different implementations of the computing device 600, the communications medium 622 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 602 stores various types of data and/or software instructions. For instance, in the example of FIG. 6, the memory 602 stores a Basic Input/Output System (BIOS) 624, an operating system 626, application software 628, and program data 630. The BIOS 624 includes a set of software instructions that, when executed by the processing system 604, cause the computing device 600 to boot up. The operating system 626 includes a set of software instructions that, when executed by the processing system 604, cause the computing device 600 to provide an operating system that coordinates the activities and sharing of resources of the computing device 600. Example types of operating systems include, but are not limited to, Microsoft Windows®, Linux, Unix, Apple OS X, Apple OS X iPhone, Palm webOS, Palm OS, Google Chrome OS, Google Android OS, and so on. The application software 628 includes a set of software instructions that, when executed by the processing system 604, cause the computing device 600 to provide applications to a user of the computing device 600. The program data 630 is data generated and/or used by the application software 628.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

We claim:

1. A method comprising:
generating, by a computing system, resource data that represents a resource, the content of the resource data being dependent on a ranking of resources in a set of resources, the ranking of the resources being dependent on interactions between users in a set of users and the resources, the ranking of the resources also being dependent on a degree to which each of the users is related to a user.

2. The method of claim 1, further comprising:
receiving, by the computing system, a resource request from a client system associated with the user, the resource request representing a request for the resource; and
sending, by the computing system, the resource data to the client system in response to the resource request.

3. The method of claim 2,
wherein the resource request comprises a query,
wherein the method further comprises: identifying the resources, each of the resources being a resource that satisfies the query, and
wherein the resource is a web page containing a set of links to least some of the resources, the links ordered in the web page according to the ranking of the resources.

4. The method of claim 3,
wherein the set of users is a first set of users, the ranking of resources is a first ranking of the resources, and the set of links is a first set of links; and
wherein the web page contains a second set of links to at least some of the resources, the links in the second set of links ordered in the web page according to a second ranking of the resources, the second ranking of the resources being dependent on interactions between users in a second set of users and the resources and a degree to which each user in the second set of users is related to the user, the second set of users being different than the first set of users.

5. The method of claim 1,
wherein the method further comprises: recording activity data that indicates how individual ones of the users interacted with individual resources in the set of resources, wherein associations between the activity data and the individual ones of the users are maintained, and
wherein generating the resource data comprises: using the activity data to determine the interactions between the users and the resources.

6. The method of claim 5,
wherein the method further comprises: receiving client-generated activity data from client devices associated with the users, the client-generated activity data indicating how the individual ones of the users interacted with ones of the resources, and
wherein recording the activity data comprises: recording the client-generated activity data such that associations between the client-generated activity data and the users is maintained.

7. The method of claim 6,
wherein the method further comprises: generating server-generated activity data, the server-generated activity data indicating how individual ones of the users interacted with the individual ones of the resources; and
wherein recording the activity data comprises: recording the server-generated activity data such that associations between the server-generated activity data and the users is maintained.

8. The method of claim 5,
wherein generating the resource data comprises:
calculating a user interaction score for each user-resource pair in the set of users and the set of resources, wherein the user interaction score for a user-resource pair is calculated using the activity data that indicates how the user in the user-resource pair interacted with the resource in the user-resource pair;
generating an activity score for each of the resources by totaling the user interaction scores for each user-resource pair specifying the resource; and
ranking the resources based at least in part on the activity scores for the resources.

9. The method of claim 8, wherein the user interaction score for one of the user-resource pair is calculated using at least one of the following types of activity data: a length of time a window containing the resource in the user-resource pair was in a foreground of a user interface displayed to the user in the user-resource pair, a length of time the user worked in the window containing the resource, a number of times the user in the user-resource pair brought the window containing the resource in the user-resource pair to the foreground of the user interface, a number of times the user in the user-resource pair printed the resource in the user-resource pair, a number of times the user in the user-resource pair copied and pasted information out of the resource in the user-resource pair, whether the user in the user-resource pair edited the resource in the user-resource pair, and whether the user in the user-resource pair forwarded the resource in the user-resource pair to another user.

10. The method of claim 8,
wherein generating the resource data comprises: calculating a social score for each of the users, the social score for a given user indicating a degree to which the given user is related to the user; and
wherein the user interaction score for each user-resource pair is dependent on the social score of the user in the user-resource pair.

11. The method of claim 10, wherein the social score for the given user is calculated, at least in part, on at least one of the following factors: how close the given user is within an organization to the user, how frequently the given user communicates with the user, whether the given user and the user have a same job title, whether there are social networking links between the given user and the user, a number of email distribution lists that contain both the given user and the user.

12. The method of claim 1, wherein the user specifies the set of users.

13. A computing system comprising:
a processing system comprising at least one processing unit; and
a data storage system storing computer-readable instructions that, when executed by the processing system, cause the computing system to:
receive a resource request from a client system used by a user, the resource request representing a request for a resource;
generate resource data that represents the resource, the content of the resource data being dependent on a ranking of resources in a set of resources, the ranking of the resources being dependent on interactions between users in a set of users and the resources, the ranking of the resources also being dependent on a degree to which each of the users is related to the user; and
send the resource data to the client system in response to the resource request.

14. The computing system of claim 13,
wherein the resource request comprises a query,
wherein the computer-readable instructions, when executed by the processing system, cause the computing system to identify the set of resources, each resource in the set of resources being a resource that satisfies the query, and
wherein the resource is a web page containing a set of links to least some of the resources, the links ordered in the web page according to the ranking of the resources.

15. The computing system of claim 13,
wherein the computer-readable instructions, when executed by the processing system, cause the computing system to:
record activity data that indicates how individual ones of the users interacted with individual ones of the resources, wherein associations between the activity data and the individual ones of the users are maintained; and
use the activity data to determine the interactions between the users and the resources.

16. The computing system of claim 15, wherein the computer-readable instructions, when executed by the processing system, cause the computing system to:
generate server-generated activity data, the server-generated activity data indicating how individual ones of the users interacted with individual ones of the resources;
record the server-generated activity data such that associations between the server-generated activity data and the users is maintained;
receive client-generated activity data from client devices associated with the users, the client-generated activity data indicating how individual ones of the users interacted with individual ones of the resources, and
record the client-generated activity data such that associations between the client-generated activity data and the users is maintained,
wherein the server-generated activity data and the client-generated activity data are used to determine the interactions between the users and the resources.

17. The computing system of claim 15, wherein the computer-readable instructions, when executed by the processing system, cause the computing system to:
calculate a user interaction score for each user-resource pair in the set of users and the set of resources, wherein the user interaction score for a user-resource pair is calculated using the activity data that indicates how the user in the user-resource pair interacted with the resource in the user-resource pair;
generate an activity score for each of the resources by totaling the user interaction scores for each user-resource pair specifying the resource; and
rank the resources based at least in part on the activity scores for the resources.

18. The computing system of claim 17,
wherein the computer-readable instructions, when executed by the processing system, cause the computing system to calculate a social score for each of the users, the social score for a given user indicating a degree to which the given user is related to the user;
wherein the user interaction score for each user-resource pair is dependent on the social score of the user in the user-resource pair.

19. The computing system of claim 13, wherein the set of users includes the user.

20. A computer-readable data storage medium that stores computer-readable instructions, the computer-readable instructions, when executed by one or more processing units of a computing system, cause the computing system to:
receive client-generated activity data from client devices used by users in a set of users, the client-generated activity data indicating how individual users in the set of users interacted with resources in a set of resources;
generate server-generated activity data, the server-generated activity data indicating how individual ones of the users interacted with individual ones of the resources;
record the client-generated activity data such that associations between the client-generated activity data and the users is maintained;
record the server-generated activity data such that associations between the server-generated activity data and the users is maintained;
receive a resource request from a client system used by a user, the resource request representing a request for a search results web page, the resource request comprising a search query;
identify a set of relevant resources, each resource in the set of relevant resources being a resource in the set of resources that satisfies the search query;
identify a set of relevant users, the set of relevant users including one or more of the users;
calculate a social score for each user in the set of relevant users, the social score for a given user indicating a degree to which the given user is related to the user;
calculate a user interaction score for each user-resource pair in the set of relevant users and the set of relevant resources, wherein the user interaction score for a user-resource pair is calculated using the client-generated activity data and the server-generated activity data related to the user in the user-resource pair and the resource in the user-resource pair, wherein the user interaction score for the user-resource pair is also calculated using the social score for the user in the user-resource pair;
generate an activity score for each resource in the set of relevant resources by totaling the user interaction scores for each of the user-resource pairs specifying the resource;
rank the resources in the set of relevant resources based at least in part on the activity scores for the resources in the set of relevant resources;
generate resource data representing the search results web page, the search result web page comprising a set of links to resources in the set of relevant resources, the links being ordered in the search results web page according to the rank of the resources in the set of relevant resources; and
send the resource data to the client system as a response to the resource request.
